(19) United States
(12) Patent Application Publication
(10) Pub. No.: US 2016/0187967 A1
(43) Pub. Date: Jun. 30, 2016

(54) VIDEO IMAGE DISPLAY DEVICE AND METHOD

(71) Applicant: FUJITSU LIMITED, Kawasaki-shi (JP)

(72) Inventors: Teruyuki SATO, Tama (JP); Norihiro Kakuko, Kawasaki (JP)

(73) Assignee: FUJITSU LIMITED, Kawasaki (JP)

(21) Appl. No.: 14/950,619

(22) Filed: Nov. 24, 2015

(30) Foreign Application Priority Data
Dec. 25, 2014 (JP) 2014-263193

(51) Int. Cl. G06F 3/01; H04N 13/04; G02B 27/01; G09G 3/34

(52) U.S. Cl. CPC G06F 3/011; G09G 3/3406; H04N 13/0429; G02B 27/0172; G09G 2360/16; G02B 2027/014

(57) ABSTRACT

A head-mountable video image display device includes: a display to be placed in a visual field of one of eyes; and a processor coupled to the display and configured to: control the display to display a video image including display information to be gazed by a user, and control the display to display, on the video image, a still image pattern having high and low luminance values and inducing motion illusion.

### CROSS-REFERENCE TO RELATED APPLICATION

This application is based upon and claims the benefit of priority of the prior Japanese Patent Application No. 2014-263193, filed on Dec. 25, 2014, the entire contents of which are incorporated herein by reference.

### FIELD

The embodiment discussed herein is related to a video image display device and a video image display method.

### BACKGROUND

In recent years, as one type of wearable terminals to be mounted on bodies and using computing resources, head-mountable video image display devices are known, which each present information on a display that is placed in a visual field of a person wearing the device. Among the video image display devices, there is a monocular video image display device that has a display to be placed in a visual field of one eye of a person wearing the device and has the person recognize information by the single eye.

If the person wears the monocular video image display device, the person recognizes different pictures by both left and right eyes and thus binocular rivalry occurs and causes fatigue.

Traditionally, as measures to suppress binocular rivalry, methods of prioritizing an eye with a visual field in which a display is placed have been considered.

As one of the methods, the following method is known: a method of displaying a video image on a display and prioritizing an eye with a visual field in which the display is placed, by using eye's visual field characteristics in which attention is paid to a motion within a peripheral part of the visual field if the motion within the peripheral part is detected.

For example, a related-art technique is disclosed in “Progress in Study on Binocular Rivalry, Tokyo Institute of Technology, Kazumichi Matsumiya, VISION, Vol. 14, No. 4, 151-164, 2002”.

### SUMMARY

According to an aspect of the invention, a head-mountable video image display device includes: a display to be placed in a visual field of one of eyes; and a processor coupled to the display and configured to: control the display to display a video image including display information to be gazed by a user, and control the display to display, on the video image, a still image pattern having high and low luminance values and inducing motion illusion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram describing a visual field of a human and photoreceptor cells;

FIG. 2 is a diagram illustrating an example of an image having patterns that cause motion illusion;

FIG. 3 is a diagram describing focus adjustment;

FIG. 4 is a diagram illustrating an example of a hardware configuration of a video image display device;

FIG. 5 is a diagram describing a functional configuration of the video image display device;

FIG. 6 is a diagram describing a specific pattern generating unit;

FIG. 7 is a diagram illustrating an example of a γ correction table;

FIG. 8 is a flowchart of operations of the video image display device;

FIGS. 9A, 9B, and 9C are diagrams describing the generation of a pattern image;

FIGS. 10A and 10B are diagrams describing the superimposition of pattern images;

FIG. 11 is a first diagram illustrating another example of the pattern images; and

FIG. 12 is a second diagram illustrating another example of the pattern images.

### DESCRIPTION OF EMBODIMENT

In the aforementioned methods, a video image is displayed on a display, but it is difficult to achieve a sufficient frame rate, transmission rate, and information processing capability for the display of the video image in a wearable terminal.

According to an aspect, an object is to provide a video image display device and video image display method that may reduce a process load and power to be consumed.

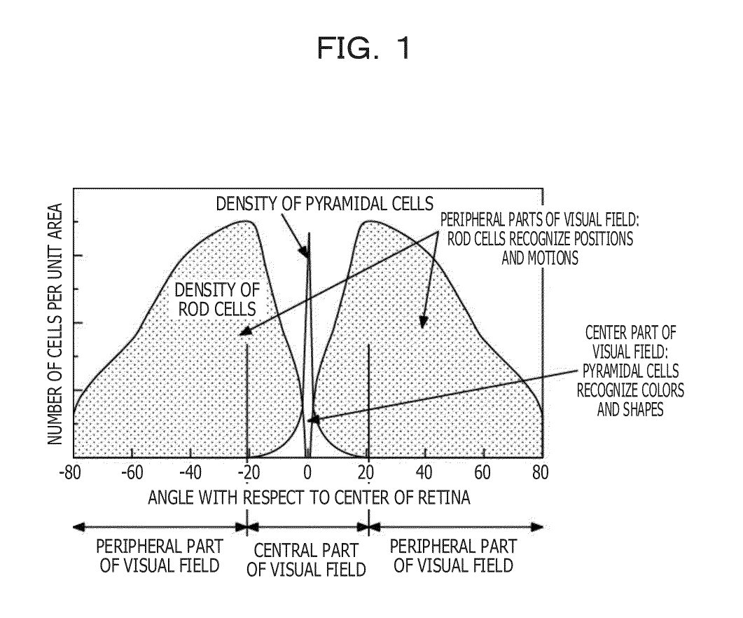

Hereinafter, an embodiment is described with reference to the accompanying drawings. First, viewpoints to which attention is paid in the embodiment are described with reference to FIGS. 1 to 3.

FIG. 1 is a diagram describing a visual field of a human and photoreceptor cells. As illustrated in FIG. 1, pyramidal cells gather in central parts of retinas of the human, and rod cells are distributed in peripheral parts of the retinas.

The pyramidal cells of each eye have the human feel colors and shapes and exist in a central part of a visual field, while the rod cells of each eye sensitively react to positions and motions of objects in an overall wide visual field extending at an angle of ±90 degrees or greater in a horizontal direction. Thus, even if an object moves in an end part of a visual field, the human has visual sense characteristics of becoming aware of the object without recognizing what is the object and turning the eyes and the body to the object so as to try to find out what is the object.

In addition, if patterns are repeatedly displayed on an image with specific high and low luminance values, the human has visual sense characteristics of feeling motions of the patterns that cause motion illusion.

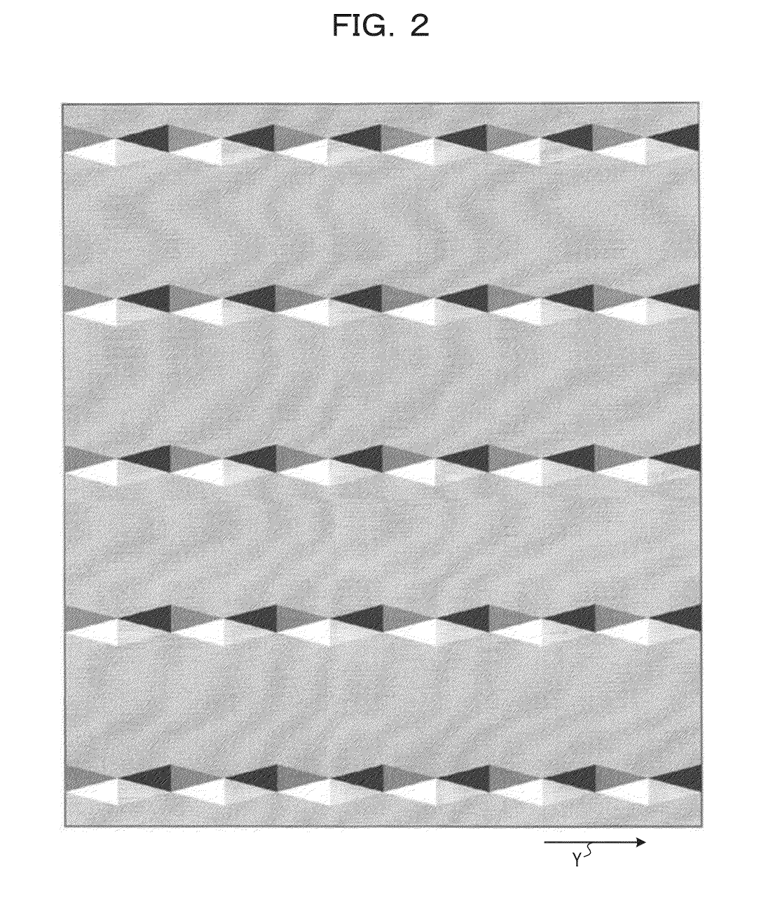

FIG. 2 is a diagram illustrating an example of the image having the patterns that cause the motion illusion. Regarding the human's visual sense characteristics, as illustrated in FIG. 2, if pattern images in which black, dark gray, white, and light gray regions are repeatedly arranged are displayed, the pattern images cause motion illusion that makes the human feel that the pattern images move in Y direction indicated by an arrow, for example.

The embodiment pays attention to the aforementioned two types of characteristics. Specifically, in the embodiment, in a monocular video image display device, a process load and power to be consumed are reduced and binocular rivalry is reduced by using human's visual sense characteristics sensitive to a motion and using a still image pattern causing motion illusion to achieve an effect of feeling a motion of an object.

The motion illusion tends to be strong in peripheral parts of a visual field of each eye. Specifically, the motion illusion is strong in peripheral parts of a visual field of each eye that each correspond to a viewing angle greater than approximately 5 degrees and are ranges in which pyramidal cells gather, the eyesight may be applied, and the eyes come into focus.

In the peripheral parts of the visual fields that each correspond to the viewing angle greater than 5 degrees, mosaic perceptual alternation occurs. Thus, in the embodiment, it is preferable that each pattern image be arranged in a respective region corresponding to a viewing angle of 5 degrees in order to prioritize an overall screen in a stable manner.

In addition, humans have visual sense characteristics in which an image having contrast may more strongly induce the adjustment of the focus of the eyes than an image having no contrast and thus may be prioritized.

A pattern image that causes motion illusion has clear boundaries (edges) and has contrast. In the embodiment, by displaying a pattern image on a display, the adjustment of the focus of an eye with a visual field in which the pattern image comes into sight is induced and prioritized.

In general, a virtual distance between the person wearing the monocular video image display device and a virtual image displayed on the display do not match a distance between the person and a certain object that exists in the real world. In this case, if the person who wears the video image display device is able to adjust the focus of an eye that is located on the side of the video image display device, edges seen by the other eye are unclear and the eye that is located on the side of the video image display device is prioritized. Thus, in the embodiment, by displaying the aforementioned pattern image and a virtual image 32 on the display 2, the adjustment of the focus of the right eye of the person who wears the video image display device is induced and the virtual image 32 is prioritized.

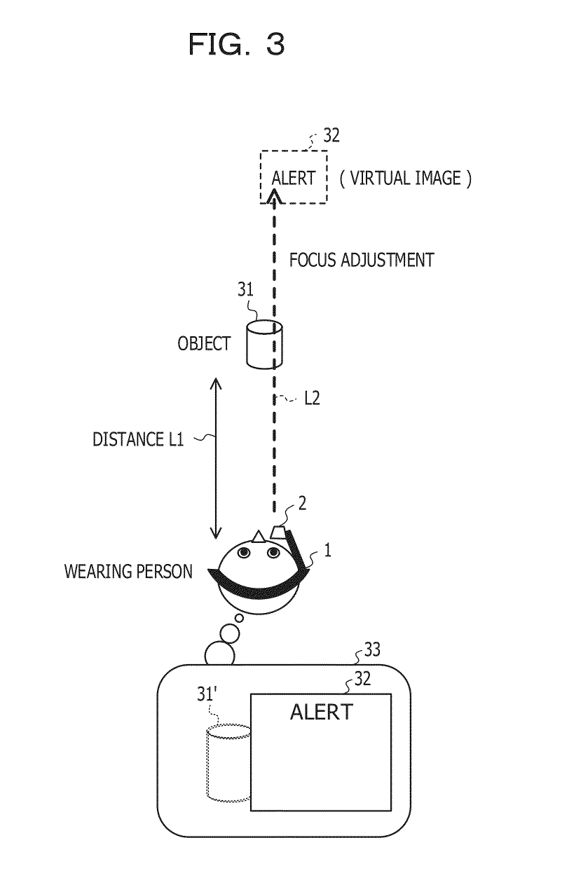

FIG. 3 is a diagram describing the focus adjustment. In FIG. 3, the person wears the monocular video image display device 1 over the right eye, a certain object 31 on which the wearing person performs a task and that exists in the real world is located, where the wearing person may reach the object 31 with a hand, and a distance between the wearing person and the object 31 is indicated by L1.

A virtual distance L2 between the wearing person and the virtual image 32 displayed on the display 2 of the video image display device 1 is determined based on design values, and it is difficult to match the distance L1 with the virtual distance L2.

In this state, if the wearing person focuses the eye on the display of the video image display device 1, the wearing person does not focus on the object 31. As a result, when the person looks at the object 31 by both eyes, the object 31 looks like an unclear object 31′ as indicated in a visual field 33, and the virtual image 32 on which the eyes focus is prioritized.

Regarding the capability of adjusting the focus, most of all pyramidal cells of each eye that recognize colors and shapes gather in a range corresponding to a viewing angle of approximately ±2.5 degrees, as illustrated in FIG. 1. In the range, a human angular resolution (eyesight) is applied. The eyesight, however, is reduced to approximately 1/10 of the original eyesight outside the range. Specifically, in order to adjust the focus, each pattern image is to be arranged in a respective region corresponding to a viewing angle of 5 degrees.

It is, therefore, desirable that each pattern image according to the embodiment is to be arranged in a respective region corresponding to a viewing angle of 5 degrees.

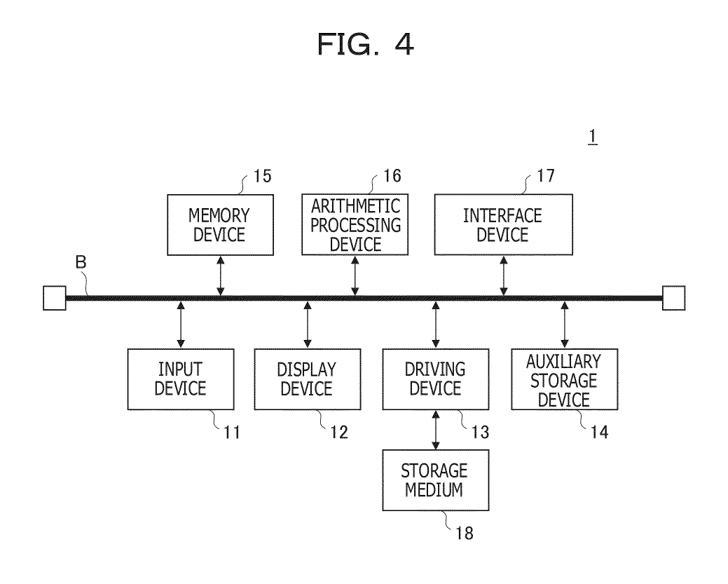

Hereinafter, the video image display device that is based on the aforementioned two types of characteristics is described. The video image display device 1 according to the embodiment is a monocular video-through head mounted display (HMD). FIG. 4 is a diagram illustrating an example of a hardware configuration of the video image display device.

The video image display device 1 according to the embodiment includes an input device 11, a display device 12, a driving device 13, an auxiliary storage device 14, a memory device 15, an arithmetic processing device 16, and an interface device 17 that are connected to each other by a bus B.

The input device 11 receives data of various types. Specifically, the input device 11 receives an image and video image to be displayed on the display device 12. The display device 12 is the display 2 or the like. For example, the display device 12 according to the embodiment is a display that covers a region corresponding to 10% or more (approximately 20%) of a visual field of one eye of the person wearing the video image display device 1.

The interface device 17 causes the video image display device 1 to be connected to a network. A video image display program is at least a part of various programs for controlling the video image display device 1. The video image display program is provided by the distribution of a storage medium 18 or is downloaded from the network and provided, for example. As the storage medium 18 storing the video image display program, any of various storage media such as storage media that are a CD-ROM, a flexible disk, a magneto optical disc, and the like and are configured to optically, electrically, and magnetically store information and semiconductor memories that are a ROM, a flash memory, and the like and are configured to electrically store information may be used.

If the storage medium 18 storing the video image display program is set in the driving device 13, the video image display program is installed in the auxiliary storage device 14 from the storage medium 18 through the driving device 13. If the video image display program is downloaded from the network, the video image display program is installed in the auxiliary storage device 14 through the interface device 17.

The auxiliary storage device 14 stores the installed video image display program, files, data, and the like. The memory device 15 reads and stores the video image display program from the auxiliary storage device 14 upon the activation of the video image display device 1. Then, the arithmetic processing device 16 achieves various processes (described later) in accordance with the video image display program stored in the memory device 15.

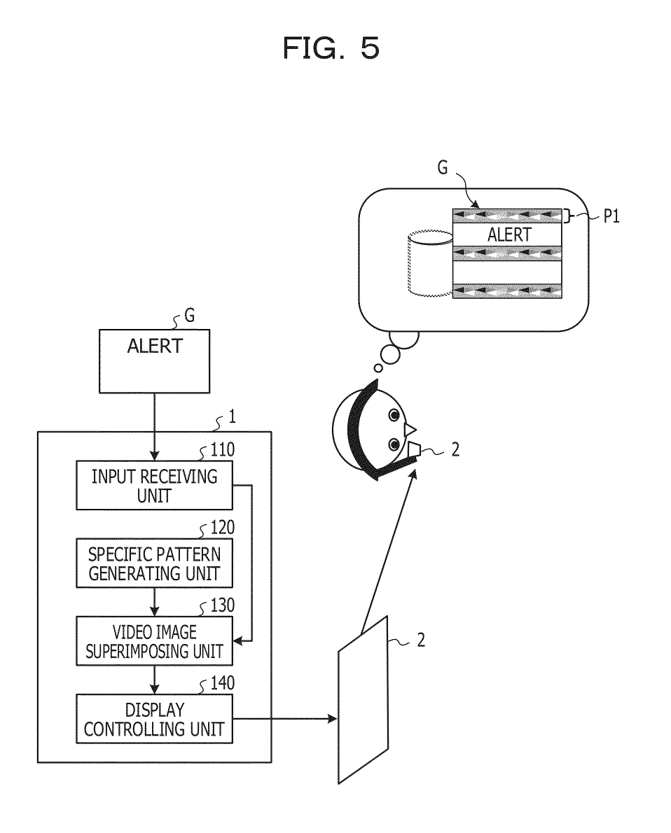

Next, functions of the video image display device 1 are described with reference to FIG. 5. FIG. 5 is a diagram describing a functional configuration of the video image display device.

The video image display device 1 according to the embodiment achieves functions of the following units by causing the arithmetic processing device 16 to execute the video image display program. The video image display device 1 according to the embodiment includes an input receiving unit 110, a specific pattern generating unit 120, a video image superimposing unit 130, and a display controlling unit 140.

The input receiving unit 110 according to the embodiment receives the input of a video image to be displayed by the video image display device 1. The video image received by the input receiving unit 110 is to be displayed on the display 2 and includes information to be recognized by the person wearing the video image display device 1.

When the video image is input, the specific pattern generating unit 120 generates a pattern image including repeatedly arranged images having the aforementioned specific high and low luminance values. The video image superimposing unit 130 generates a superimposed video image obtained by superimposing the pattern image on the input video image. The generation of the pattern image by the specific pattern generating unit 120 and the superimposition on the video image by the video image superimposing unit 130 are described later in detail. The display controlling unit 140 controls display of the superimposed video image generated by the video image superimposing unit 130.

When the input receiving unit 110 receives a video image G, the video image display device 1 according to the embodiment causes the specific pattern generating unit 120 to generate a pattern image P1 and causes the video image superimposing unit 130 to superimpose the pattern image P1 at a predetermined position on the video image G. Then, the video image display device 1 causes the display controlling unit 140 to display, on the display 2, the superimposed video image obtained by superimposing the pattern image P1 on the video image G.

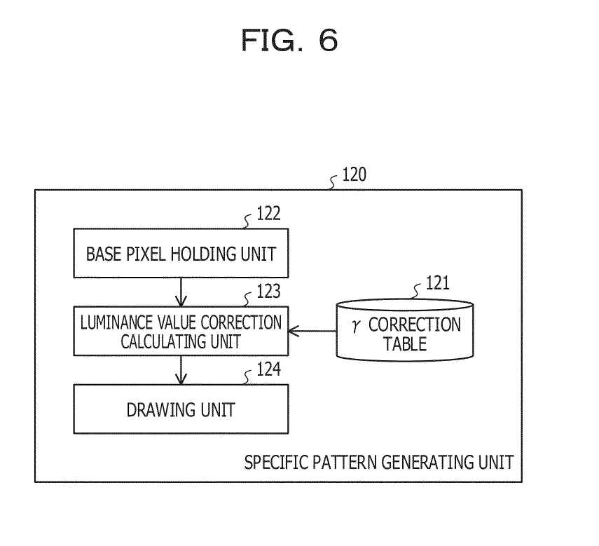

Next, the specific pattern generating unit 120 according to the embodiment is described with reference to FIG. 6. FIG. 6 is a diagram describing the specific pattern generating unit.

The specific pattern generating unit 120 according to the embodiment executes, based on γ characteristics of the display 2, γ correction on luminance values of pixels forming patterns and generates the pattern image.

The display has luminance response characteristics for an input signal, and the signal may not be proportional to the brightness of the screen. In general, it is known that if a luminance value is x (it is assumed that the maximum luminance value is 1) and the brightness of the screen is y (it is assumed that the maximum brightness is 1), the characteristics of the display may be approximated by an equation of (y=x^{γ}). The value of γ varies depending on the type and settings of the display. Normally, if luminance values that are indicated by 256 gray levels are provided to the display, the screen may be dark and the pattern image may not be appropriately displayed.

In the embodiment, in order to generate the pattern image, the γ correction is executed to increase the luminance values and approximate the characteristics of the display to a straight line as much as possible.

The specific pattern generating unit 120 according to the embodiment includes a γ correction table 121, a base pixel holding unit 122, a luminance value correction calculating unit 123, and a drawing unit 124.

The γ correction table 121 is referenced upon the γ correction. The base pixel holding unit 122 holds pixel values corresponding to black, dark gray, white, and light gray regions forming the pattern image.

The luminance value correction calculating unit 123 references the γ correction table 121, corrects the luminance values held by the base pixel holding unit 122, and determines luminance values to be used to finally draw the pattern image. Details of the luminance value correction calculating unit 123 are described later. The drawing unit 124 uses the corrected luminance values to form the pattern image.

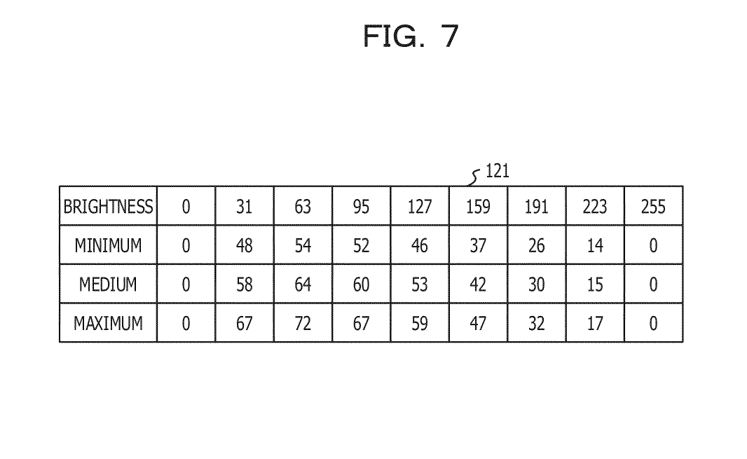

FIG. 7 is a diagram illustrating an example of the γ correction table. The γ correction table 121 according to the embodiment may be stored in the auxiliary storage device 14 or the like. If the luminance values that are indicated by the 256 gray levels are indicated by 8 levels, the γ correction table 121 according to the embodiment indicates luminance values to be added in order to set the brightness of the display to brightness corresponding to the luminance values indicated by the 256 gray levels.

Referring to FIG. 7, the brightness is indicated by luminance values when the 256 gray levels are indicated by the 8 levels. In FIG. 7, “minimum”, “medium”, and “maximum” indicate set levels of the brightness (luminance) of the display 2. If the brightness of the display 2 according to the embodiment may be changed by control of the amount of light to be supplied to a backlight, the brightness may be set using the three levels, the “minimum”, the “medium”, and the “maximum”.

In FIG. 7, values associated with the “minimum”, the “medium”, and the “maximum” are correction values for luminance. For example, if the brightness is set to the “minimum” and a signal of a luminance value “31” is input, a luminance value “79” obtained by adding a correction value “48” to the luminance value “31” is a luminance value to be used to finally draw the pattern image.

The correction values of the γ correction table 121 illustrated in FIG. 7 are obtained by inputting signals of the luminance values indicated by the 256 gray levels to the display 2 and conducting an experiment or the like so as to measure the brightness of the screen of the display 2. The γ correction table 121 is provided in advance based on the characteristics of the display included in the video image display device 1, for example. In the example illustrated in FIG. 7, the luminance values indicated by the 256 gray levels are represented by the 8 levels. The luminance values indicated by the 256 gray levels, however, may be represented by a larger number of levels, for example, 32 levels.

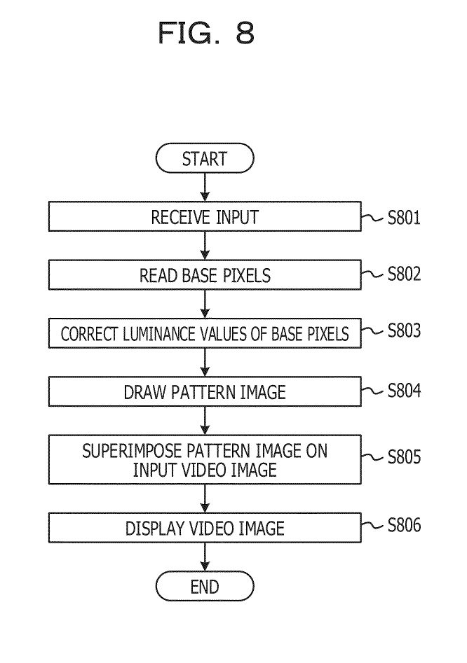

Next, operations of the video image display device 1 according to the embodiment are described with reference to FIG. 8. FIG. 8 is a flowchart of the operations of the video image display device.

The video image display device 1 according to the embodiment causes the input receiving unit 110 to receive the input of a video image to be displayed on the display 2 (in step S801). Subsequently, the specific pattern generating unit 120 causes the luminance value correction calculating unit 123 to read base pixels held by the base pixel holding unit 122 (in step S802). The base pixels are pixels forming the pattern image and have the luminance values indicated by the 256 gray levels.

Subsequently, the specific pattern generating unit 120 causes the luminance value correction calculating unit 123 to reference the γ correction table 121, correct the luminance values of the base pixels (in step S803), and determine luminance values to be used to draw the pattern image. Then, the specific pattern generating unit 120 causes the drawing unit 124 to draw the pattern image using the luminance values determined in step S803 (in step S804).

Subsequently, the video image display device 1 causes the video image superimposing unit 130 to superimpose the drawn pattern image on the input video image (in step S805) and provide the video image having the pattern image superimposed thereon to the display controlling unit 140. The display controlling unit 140 displays the video image having the pattern image superimposed thereon on the display 2 (in step S806).

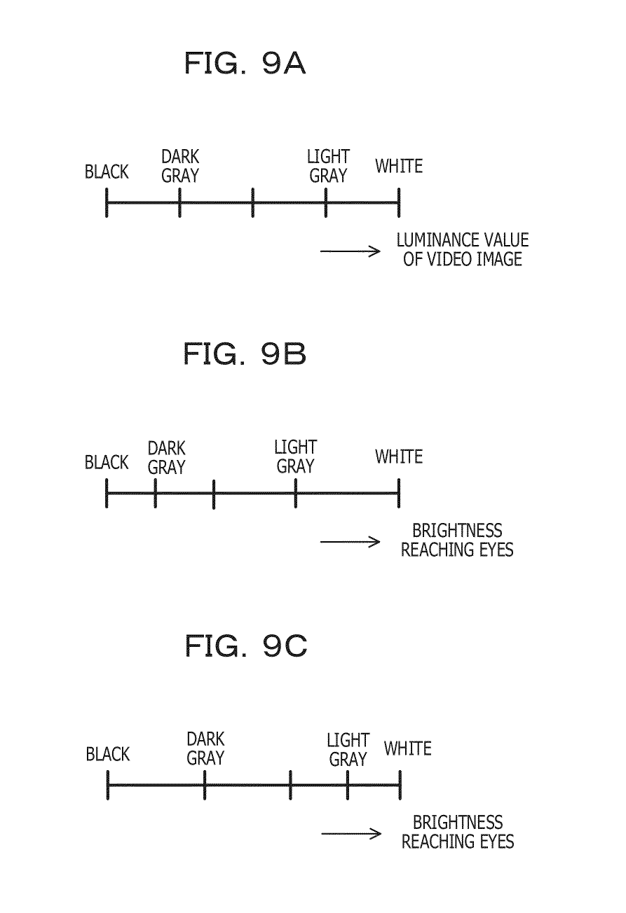

The generation of the pattern image by the specific pattern generating unit 120 is described below with reference to FIGS. 9A, 9B, and 9C.

FIGS. 9A to 9C are diagrams describing the generation of the pattern image. The pattern image according to the embodiment includes an image of patterns that may cause Fraser-Wilcox illusion, for example. FIG. 9A is a diagram describing characteristics of luminance of the pattern image. FIG. 9B is a diagram describing characteristics of the luminance of the pattern image when the γ value of the display is higher than 1. FIG. 9C is a diagram describing characteristics of the luminance of the pattern image when the γ value of the display is lower than 1.

If the luminance of the pattern image according to the embodiment is divided into 4 levels between the minimum luminance (hereinafter referred to as black) and the maximum luminance (hereinafter referred to as white), luminance that is lower than the center value of the luminance of the display is referred to as dark gray, and luminance that is higher than the center value of the luminance of the display is referred to as light gray.

In the embodiment, the motion illusion is induced by repeatedly arranging images of black, dark gray, white, and light gray.

Specifically, the pattern image according to the embodiment includes images of first to fourth luminance whose values are different from each other. If the first luminance (or the minimum luminance)<the second luminance<the third luminance<the fourth luminance (or the maximum luminance), the pattern image is an image in which the image of the first luminance, the image of the second luminance, the image of the fourth luminance, and the image of the third luminance are repeatedly arranged in this order.

The first to fourth luminance values are the luminance values of the base pixels and are held by the base pixel holding unit 122.

It is desirable that differences between the first to fourth luminance values be maintained in the pattern image when the pattern image reaches the eyes of the observing person. The differences between the first to fourth luminance values, however, vary depending on the γ characteristics of the display 2.

Specifically, as illustrated in FIG. 9B, if the γ value of the display is higher than 1, a gray level that corresponds to black is not appropriate, the difference between the luminance values corresponding to black and dark gray is smaller than the difference, to be originally secured, between the luminance values corresponding to black and dark gray, and the difference between the luminance values corresponding to white and light gray is larger than the difference, to be originally secured, between the luminance values corresponding to white and light gray, for example.

In addition, as illustrated in FIG. 9C, if the γ value of the display is lower than 1, a gray level that corresponds to white is not appropriate, the difference between the luminance values corresponding to white and light gray is smaller than the difference, to be originally secured, between the luminance values corresponding to white and light gray, and the difference between the luminance values corresponding to black and dark gray is larger than the difference, to be originally secured, between the luminance values corresponding to black and dark gray, for example.

Even if the pattern image is generated and appropriate for the induction of the motion illusion, the pattern image may not have the differences between the luminance values that are to be originally secured for the pattern image, depending on the γ characteristics of the display, and a sufficient effect may not be obtained.

Thus, the specific pattern generating unit 120 according to the embodiment causes the luminance value correction calculating unit 123 to references the γ correction table 121 and corrects the luminance values held by the base pixel holding unit 122.

The correction of the luminance values by the luminance value correction calculating unit 123 is described below in detail. An example described below assumes that the first, second, third, and fourth luminance values held by the base pixel holding unit 122 are “0”, “54”, “202”, and “255”, respectively.

First, a case where the brightness of the display 2 is set to the “minimum” is described below.

The first luminance value is “0”, and the γ correction table 121 indicates that a correction value when the brightness is 0 or the “minimum” is “0”. Thus, the first luminance value is “0” after the correction.

The second luminance value is “54”. Since the value “54” that is the luminance value of base pixels does not exist in the γ correction table 121, the luminance value correction calculating unit 123 calculates a correction value for the second luminance value by an interpolation method such as linear interpolation.

In this case, the correction value is ((54−48)/(63−31))×(54−31)+48=52. Thus, the luminance value correction calculating unit 123 sets, as a luminance value to be used for the final drawing, a luminance value “106” obtained by adding the correction value “52” to the luminance value 54 of the base pixels.

Similarly, a correction value for the luminance value 202 of base pixels is ((26−14)/(223−191))×(202−191)+14=18. Thus, the luminance value correction calculating unit 123 sets, as a luminance value to be used for the final drawing, a luminance value “220” obtained by adding the correction value “18” to the luminance value “202” of the base pixels.

Similarly, a correction value for the luminance value 255 of base pixels is “0”. Thus, the fourth luminance value is also “255” after the correction.

Specifically, the luminance values of the base pixels are (0, 54, 202, 255). If the brightness of the display 2 is set to the “minimum”, the luminance values for the pixels that are used by the drawing unit 124 for the final drawing are (0, 106, 220, 255).

Next, a case where the brightness of the display 2 is set to the “medium” is described. In this case, the correction value for the second luminance value is ((64−58))/(63−31))×(54−31)+58=62, and the correction value for the third luminance value is ((30−15))/(223−191))×(202−191)+15=20.

Specifically, the luminance values of the base pixels are (0, 54, 202, 255). If the brightness of the display 2 is set to the “medium”, the luminance values of the pixels that are used by the drawing unit 124 for the final drawing are (0, 116, 222, 255).

Next, a case where the brightness of the display 2 is set to the “maximum” is described. In this case, the correction value for the second luminance value is ((72−67))/(63−31))×(54−31)+67=70, and the correction value for the third luminance value is ((32−17))/(223−191))×(202−191)+17=22.

Specifically, Specifically, the luminance values of the base pixels are (0, 54, 202, 255). If the brightness of the display 2 is set to the “maximum”, the luminance values of the pixels that are used by the drawing unit 124 for the final drawing are (0, 124, 224, 255).

As described above, in the embodiment, since the pattern image is displayed on the display 2 after the correction of the luminance values based on the characteristics of the display 2 of the video image display device 1, changes in the gray levels of the pattern image due to the characteristics of the display 2 may be suppressed.

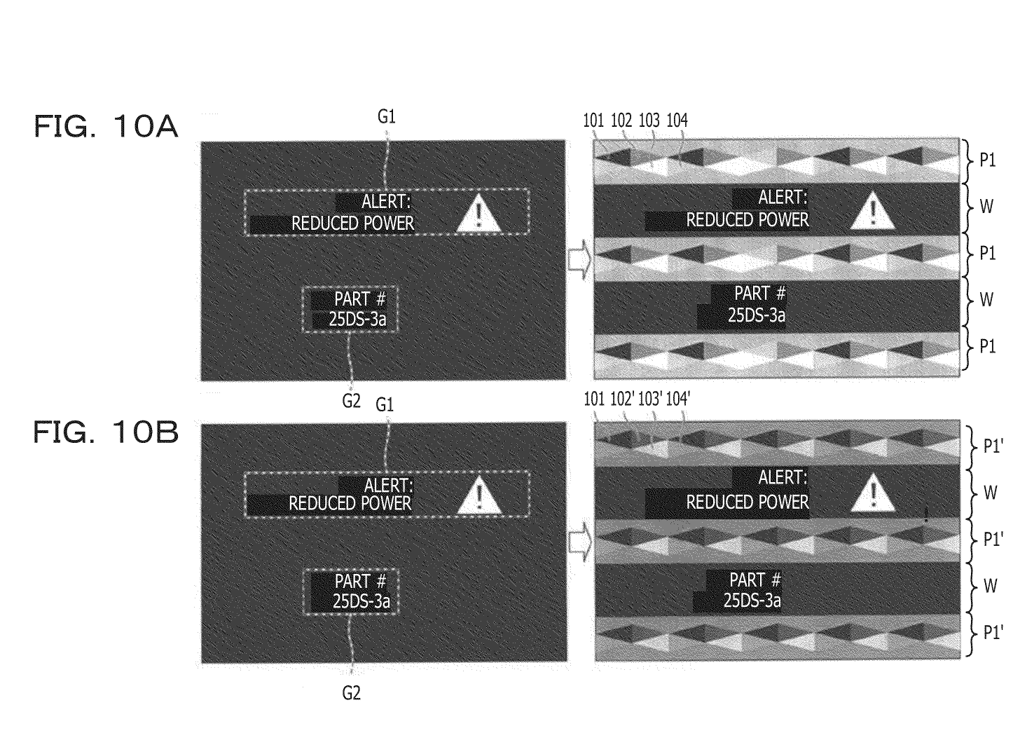

FIGS. 10A and 10B are diagrams describing the superimposition of pattern images. FIG. 10A is the diagram describing the superimposition of the pattern images when the pattern images each have repetitive patterns of luminance corresponding to black, dark gray, white, and light gray. FIG. 10B is the diagram illustrating a case where the pattern images each have colors.

In the embodiment, when the video image G is input to the video image display device 1, the video image superimposing unit 130 superimposes the pattern images P1 on the video image G. In the embodiment, each pattern image P1 is superimposed in a respective region corresponding to a viewing angle of 5 degrees.

In the video image G illustrated in FIG. 10A, the total of the width W of a region and the width of a pattern image P1 is the width of a region corresponding to a viewing angle of 5 degrees. Thus, the video image superimposing unit 130 superimposes each pattern image P1 on a respective region having the width W. The viewing angle of 5 degrees is ±2.5 degrees with respect to a viewing angle of 0 degrees. The viewing angle of 5 degrees is a guideline, and it is sufficient if the viewing angle is approximately 5 degrees.

The pattern images P1 illustrated in FIG. 10A each include a black region 101, a dark gray region 102, a white region 103, and a light gray region 104. In the example illustrated in FIG. 10A, the luminance value of the black region 101 is 0, the luminance value of the dark gray region 102 is 54, the luminance value of the white region 103 is 202, and the luminance value of the light gray region 104 is 255.

In the example illustrated in FIG. 10A, a pattern image P1 is arranged in a central region, corresponding to a viewing angle of 5 degrees or less, of the video image G. In this case, repetitive patterns are arranged in the opposite order in the central region, but may be arranged in the original order in the central region.

In addition, the video image superimposing unit 130 according to the embodiment may rewrite the pattern images P1 on the video image G in order to superimpose the pattern images P1 on the video image G. Alternatively, the video image superimposing unit 130 may synthesize the pattern images P1 with the video image G by alpha blend. The alpha blend is to make a target image transparent based on a prepared image (mask image) defining a part to be transparent and is to synthesize two images or the target image and another image with each other by a coefficient.

The video image superimposing unit 130 according to the embodiment may superimpose a pattern image on a gap located around a region in which information G1 and G2 is displayed on the display 2 so as to ensure that the region in which the information G1 and G2 is displayed does not overlap the pattern image.

FIG. 10B illustrates the case where the pattern images each have the colors. In the embodiment, patterns of pattern images P1′ are generated to ensure that boundaries between the patterns are not formed by the colors and are formed by the differences, satisfying the aforementioned requirements, between the luminance values.

A peak wavelength for the sensitivity of rod cells that represent peripheral parts of a visual field of each eye is 505 nm and corresponds to dark green. If the brightness is expressed by the colors, a mixed color of red and blue that is largely different from green may be a dark color, and a color (for example, yellow) that is close to green may be a light color.

In the pattern images P1′ illustrated in FIG. 10B, purple that is indicated by (R, G, B)=(0x78, 00x00, 0xA0) is used instead of dark gray, yellow that is indicated by (R, G, B)=(0xFF, 00xFF, 0x00) is used instead of white, and greenish yellow that is indicated by (R, G, B)=(0xAE, 00xff, 0x00) is used instead of light gray.

Thus, regions 102′ of the pattern images P1′ illustrated in FIG. 10B are the aforementioned purple, regions 103′ of the pattern images P1′ are the aforementioned yellow, and regions 104′ of the pattern images P1′ are the aforementioned greenish yellow.

In the examples illustrated in FIGS. 10A and 10B, the pattern images P1 and P1′ are displayed on the upper and lower sides of the regions in which the information G1 and G2 is displayed, but are not limited to this. The pattern images P1 and P1′ may be displayed on the left and right sides of the regions in which the information G1 and G2 is displayed, as long as each viewing angle is 5 degrees or less.

In the embodiment, pattern images other than the aforementioned pattern images may be used.

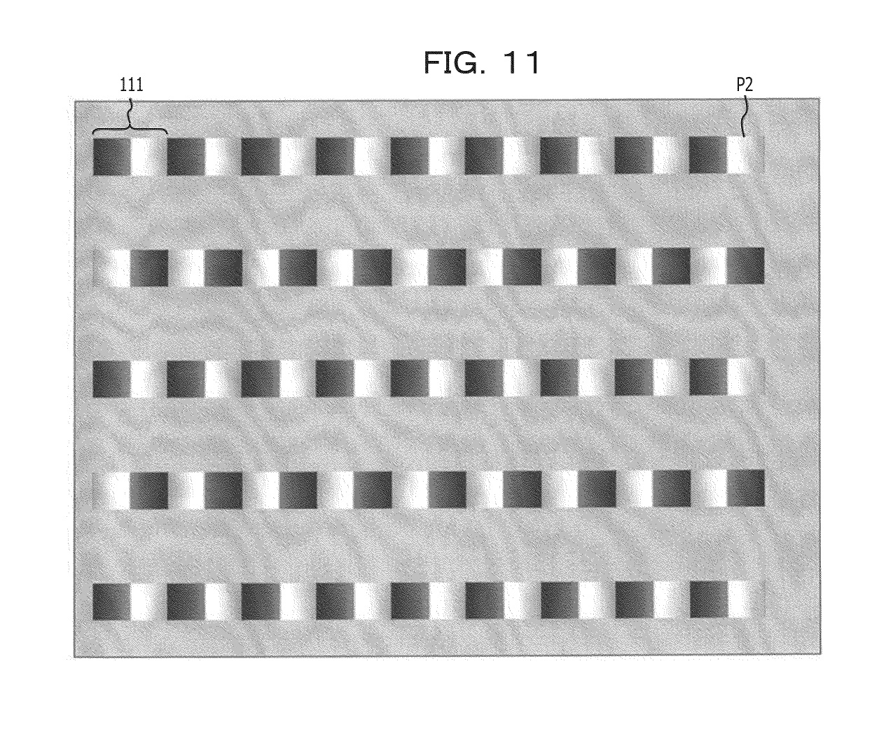

FIG. 11 is a first diagram illustrating another example of the pattern images. Pattern images P2 illustrated in FIG. 11 each have a combination of rectangular regions, instead of triangular regions. The pattern images P2 illustrated in FIG. 11 each have luminance gradients and luminance values that are not fixed, unlike the luminance values corresponding to black, dark gray, white, and light gray.

In the pattern images P2, 0, 54, 202, and 255 are selected as the luminance values that correspond to black, dark gray, white, and light gray, luminance values between the luminance value 0 corresponding to black and the luminance value 54 corresponding to dark gray are linearly interpolated by interpolation using an interpolant, and luminance values between the luminance value corresponding to dark gray and the luminance value corresponding to white are extrapolated using the interpolant.

The interpolation is to calculate values within interval ranges of a data string of known values based on the data string, while the extrapolation is to calculate values estimated to be outside ranges of data of known values, based on the data.

In the pattern images P2, luminance values between the luminance value 255 corresponding to white and the luminance value 202 corresponding to light gray are linearly interpolated by interpolation using an interpolant, and luminance values between the luminance value corresponding to light gray and the luminance value corresponding to black are extrapolated using the interpolant. In regions 111 included in the pattern images P2 and including white regions and light gray regions, boundaries between black and dark gray and boundaries between white and light gray do not have to be visually recognized.

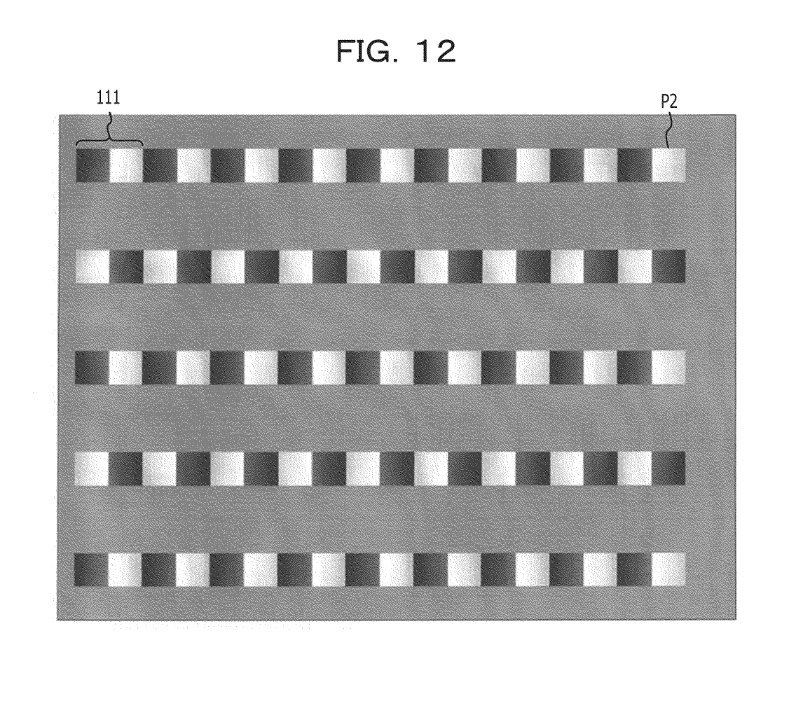

FIG. 12 is a second diagram illustrating another example of the pattern images. FIG. 12 illustrates pattern images P2′ obtained by applying colors to the pattern images P2 illustrated in FIG. 11.

In the pattern images P2′, purple that is indicated by (R, G, B)=(0x78, 00x00, 0x78) is used instead of dark gray, yellow that is indicated by (R, G, B)=(0xFF, 0xFF, 0x00) is used instead of white, and yellow that is indicated by (R, G, B)=(0xD2, 0xD2, 0x00) is used instead of light gray.

As described above, in the embodiment, by displaying pattern images inducing motion illusion in regions located around regions in which information to be recognized by the wearing person is displayed, an eye with a visual field in which the display 2 of the video image display device 1 is placed may be prioritized. Thus, according to the embodiment, a video image to be used to suppress binocular rivalry may not be displayed and a process load and power to be consumed may be reduced. In addition, in the embodiment, since binocular rivalry may be suppressed, information may be easily recognized.

Although the embodiment describes the case where each pattern image is arranged in a respective region corresponding to a viewing angle of 5 degrees or less, the embodiment indicates that it is preferable that each pattern image be arranged in a respective region corresponding to a viewing angle of approximately 5 degrees, and each viewing angle is not limited to the exact 5 degrees. For example, each pattern image may be displayed on any of the upper, lower, left, and right sides of information to be recognized so as to ensure that each pattern image is arranged in a respective region corresponding to a viewing angle of 5 degrees or less. It is sufficient if the pattern images according to the embodiment are displayed in regions corresponding to viewing angles of approximately 5 degrees at positions at which the pattern images induce motion illusion in the wearing person.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A head-mountable video image display device comprising:
a display to be placed in a visual field of one of eyes; and
a processor coupled to the display and configured to:
control the display to display a video image including display information to be gazed by a user, and
control the display to display, on the video image, a still image pattern having high and low luminance values and inducing motion illusion.

2. The head-mountable video image display device according to claim 1, wherein the still image pattern is displayed around the display information.

3. The head-mountable video image display device according to claim 1, wherein
the still image pattern is expressed using first luminance, second luminance, third luminance, and fourth luminance, and has an arrangement in order of a first region, a second region, a fourth region, and a third region when the first luminance is lower than the second luminance, the second luminance is lower than the third luminance, and the third luminance is lower than the fourth luminance,
the first region has the first luminance,
the second region has the second luminance,
the third region has the third luminance, and
the fourth region has the forth luminance.

4. The head-mountable video image display device according to claim 1, wherein
the still image pattern is expressed using first luminance, second luminance, third luminance, and fourth luminance, and has an arrangement in order of a first region and a second region, when the first luminance is lower than the second luminance, the second luminance is lower than the third luminance, and the third luminance is lower than the fourth luminance,
the first region has a luminance gradient from the first luminance to the second luminance, and
the second region has another luminance gradient from the fourth luminance to the third luminance.

5. The head-mountable video image display device according to claim 1, wherein
the still image pattern is arranged at a corresponding position, on the video image, in a region corresponding to a viewing angle of 5 degrees or less of the user.

6. The head-mountable video image display device according to claim 3, wherein the processor is configured to:
correct values of the first, second, third, and fourth luminance based on a correction table stored in a storage device, the correction table corresponding to the display device, and
generate the still image pattern based on the corrected values of the first, second, third, and fourth luminance.

7. The head-mountable video image display device according to claim 4, wherein the processor is configured to:
correct values of the first, second, third, and fourth luminance based on a correction table stored in a storage device, the correction table corresponding to the display device, and
generate the still image pattern based on the corrected values of the first, second, third, and fourth luminance.

8. A video image display method executed by a processor, the video image display method comprising:
controlling a display to display a video image including display information to be gazed by a user, the display being placed in a visual field of one of eyes of the user; and
controlling the display to display, on the video image, a still image pattern having high and low luminance values and inducing motion illusion.

9. The video image display method according to claim 8, wherein the still image pattern is displayed around the display information.

10. The video image display method according to claim 8, wherein
the still image pattern is expressed using first luminance, second luminance, third luminance, and fourth luminance, and has an arrangement in order of a first region, a second region, a fourth region, and a third region when the first luminance is lower than the second luminance, the second luminance is lower than the third luminance, and the third luminance is lower than the fourth luminance,
the first region has the first luminance,
the second region has the second luminance,
the third region has the third luminance, and
the fourth region has the forth luminance.

11. The video image display method according to claim 8, wherein
the still image pattern is expressed using first luminance, second luminance, third luminance, and fourth luminance, and has an arrangement in order of a first region and a second region, when the first luminance is lower than the second luminance, the second luminance is lower than the third luminance, and the third luminance is lower than the fourth luminance,
the first region has a luminance gradient from the first luminance to the second luminance, and
the second region has another luminance gradient from the fourth luminance to the third luminance.

12. The video image display method according to claim 8, wherein
the still image pattern is arranged at a corresponding position, on the video image, in a region corresponding to a viewing angle of 5 degrees or less of the user.

13. The video image display method according to claim 10, further comprising:
correcting values of the first, second, third, and fourth luminance based on a correction table stored in a storage device, the correction table corresponding to the display device; and
generating the still image pattern based on the corrected values of the first, second, third, and fourth luminance.

14. The video image display method according to claim 11, further comprising:
correcting values of the first, second, third, and fourth luminance based on a correction table stored in a storage device, the correction table corresponding to the display device; and
generating the still image pattern based on the corrected values of the first, second, third, and fourth luminance.

15. A non-transitory storage medium storing a video image display program which causes a computer to execute a procedure, the procedure comprising:
controlling a display to display a video image including display information to be gazed by a user, the display being placed in a visual field of one of eyes of the user; and
controlling the display to display, on the video image, a still image pattern having high and low luminance values and inducing motion illusion.

16. The non-transitory storage medium according to claim 15, wherein the still image pattern is displayed around the display information.

17. The non-transitory storage medium according to claim 15, wherein
the still image pattern is expressed using first luminance, second luminance, third luminance, and fourth luminance, and has an arrangement in order of a first region, a second region, a fourth region, and a third region when the first luminance is lower than the second luminance, the second luminance is lower than the third luminance, and the third luminance is lower than the fourth luminance,
the first region has the first luminance,
the second region has the second luminance,
the third region has the third luminance, and
the fourth region has the forth luminance.

18. The non-transitory storage medium according to claim 15, wherein
the still image pattern is expressed using first luminance, second luminance, third luminance, and fourth luminance, and has an arrangement in order of a first region and a second region, when the first luminance is lower than the second luminance, the second luminance is lower than the third luminance, and the third luminance is lower than the fourth luminance,
the first region has a luminance gradient from the first luminance to the second luminance, and
the second region has another luminance gradient from the fourth luminance to the third luminance.

19. The non-transitory storage medium according to claim 15, wherein
the still image pattern is arranged at a corresponding position, on the video image, in a region corresponding to a viewing angle of 5 degrees or less of the user.

20. The non-transitory storage medium according to claim 17, the procedure further comprising:
correcting values of the first, second, third, and fourth luminance based on a correction table stored in a storage device, the correction table corresponding to the display device; and
generating the still image pattern based on the corrected values of the first, second, third, and fourth luminance.
